(19) United States
(12) Patent Application Publication
(10) Pub. No.: US 2012/0314546 A1
(43) Pub. Date: Dec. 13, 2012

(54) TIMEPIECE WITH TWIST RESTRICTED FLEXIBLE DISPLAY

(76) Inventors: Donald R. Brewer, Long Beach, CA (US); Stefan Andren, Portland, OR (US)

(21) Appl. No.: 13/579,523

(22) PCT Filed: Feb. 17, 2011
(86) PCT No.: PCT/US2011/025283

§ 371 Date: Aug. 16, 2012

Related U.S. Application Data
(60) Provisional application No. 61/338,295, filed on Feb. 17, 2010.

(51) Int. Cl. G04B 37/12

(52) U.S. Cl. 368/281

(57) ABSTRACT

A digital wrist watch includes a flexible digital display having an axis of curvature around which the display bends that is electrically connected to a microcontroller unit and is also electrically connected to a power source. Some of the plurality of electrical connections are positioned over at least one of a plurality of links that are configured to restrict twisting of the flexible digital display. The power source includes a battery positioned in an opening defined by one of the plurality of links The battery at least partially overlaps the plane of that link, The flexible digital display is selected from the group consisting of an electrophoretic display, a liquid crystal display, or an organic light emitting diode display.

### CROSS-REFERENCE TO RELATED APPLICATIONS

This application claims priority to and the benefit of U.S. Provisional Patent Application No. 61/338,295 entitled “Mobile Device With Flexible Display” filed 17 Feb. 2010, the contents of which are incorporated herein by reference.

### BACKGROUND OF THE INVENTION

Mobile devices today ranging from cellphones, laptops, ebooks and ereaders, to digital watches all require an information display of some type to display text, graphics, or pictures. Liquid crystal displays were one of the first displays used in mobile devices and watches. Liquid crystal displays (LCDs) were initially developed in the 1970s. Due to tow power consumption. LCDs have since become the predominant display technology used in mobile devices. A LCD typically includes a layer of molecules aligned between two transparent electrodes, and two polarizing filters, the axes of transmission of which are (in most of the cases) perpendicular to each other. The liquid crystal molecules rotate when in the presence of an electric field and can be designed to enable light to either pass through the two polarizing filters or be blocked when an electric field is applied,

In the 1990s several companies began to commercialize electrophoretic display technologies. Electrophoretic displays comprise some charged particle of particular color typically placed in a display with some liquid of contrasting color. When a voltage is applied across the two plates, the particles will migrate electrophoretically to the plate bearing the opposite charge from that on the particles. When the particles are located at the front (viewing) side of the display, it appears white when using white particles such as titanium dioxide. This is because light is scattered back to the viewer by the high-index titanium particles. When the particles are located at the rear side of the display, it appears dark, because the incident light is absorbed by the colored dye. The notable advantage of electrophoretic display technology is that it is reflective, and therefore is arguably more readable than other display technologies. Electrophoretic display technology is also bi-stable so that particles remain in their desired position without any charge, which can be a major power consumption reduction for displays that may have a lengthy duty cycle. A more recent display technology to emerge commercially is the emissive organic light emitting diode (OLED) displays. An OLED is a light-emitting diode (LED) whose emissive electroluminescein layer is composed of a film of organic compounds. This layer of organic semiconductor material is formed between two electrodes, where at least one of the electrodes is transparent.

The typical flexible electrophoretic. LCD, or OLED display comprises two plastic substrates containing the chemical components that enable the display technology. These plastic substrates can be flexible. However, there typically remain significant limitations to the degree of flexibility or radius of curvature to which the product can be subject. Exceeding that flexibility or twisting the display may, for example, weaken the sealant used to hold these two outer plastic substrates together.

### SUMMARY OF THE INVENTION

This invention relates to mobile devices such as mobile phones, mobile computers, and timepieces (in particular wrist watches and other personal and/or wearable timepieces) that preferably include thin and/or flexible product designs. Various embodiments include integrated construction components and/or overall package designed to reduce twisting, and in some instances to also limit flexibility within the limits of the various flexible display technologies. The various embodiments described herein are preferably for use in applications such as watches, clocks, other timepieces, jewelry, mobile computers, and mobile phones. However, it should be understood that other portable consumer products are contemplated as within the scope of the invention.

In one embodiment there is a watch comprising a flexible digital display capable of displaying at least one of chronological, graphical, or data information. The watch further includes at least one microcontroller unit (M CU) electrically connected to the flexible display. There is also a power source electrically connected to the flexible display. The watch further comprises means for reducing twist of the flexible digital display, wherein the means for reducing twist is positioned beneath and at least partially overlaps the flexible digital display.

In another embodiment there is a watch comprising a flexible digital display capable of displaying at least one of chronological, graphical, or data information. The watch further includes at least one microcontroller unit (MCU) electrically connected to the flexible display. A power source is electrically connected to the flexible display. At least a portion of the flexible digital display spatially overlaps a means for permitting flex in a first axis and limiting flex in a second axis different from the first axis.

In another embodiment there is a digital wrist watch including a flexible display having an axis of curvature around which the display bends. The flexible display is electrically connected to a microcontroller unit and is also electrically connected to a power source. At least some of a plurality of electrical connections are positioned over at least one of a plurality of links that are configured to restrict twisting of the flexible digital display.

In another embodiment there is a timepiece comprising a flexible display positioned substantially within a polymer casing. The casing also encloses at least a portion of a means for restricting twist of the flexible display. A display face of the flexible display is adjacent to a substantially transparent portion of the casing. The flexible display is electrically connected to a power source and to controlling electronics for causing the display to present temporal information.

In another embodiment there is a timepiece comprising a twist resistant spine. The spine spatially overlaps at least some of a plurality of electrical connections between MCU, a PCB, and a flexible display capable of displaying temporal information. The spine includes a main link and a plurality of additional links. The main link defines an opening for receiving a battery positioned therein. Alternatively, one or more of the links define an opening for receiving a battery or batteries positioned therein.

In another embodiment there is a timepiece comprising a transparent layer above a flexible display bendable substantially in only a single axis. The timepiece includes a means for limiting flex to a single axis. The flexible display and a battery and a MCU and driving electronics and a PCB are all electrically connected together for causing the flexible display to present temporal information.

In another embodiment there is a watch module comprising a spine for permitting limited flex in a first axis and restricting twist in other axis. The spine spatially overlaps a flexible display electrically connected to a microcontroller and driving electronics that are electrically connected to a flexible PCB. The spine comprises a plurality of links. Adjacent links are interconnected to permit only limited flex in the first axis.

Multiple embodiments are disclosed and/or claimed herein. The variations or refinements described herein are generally applicable to most, if not all, of these embodiments. Such variations and refinement include the following individual refinements, as well as numerous combinations of these individual refinements.

In one refinement the means for restricting twist, or the means for limiting flex to a single axis, or means for permitting flex in a first axis and limiting twist in a second axis different from the first axis, or means for permitting flex in a first axis and limiting flex in a second axis different from the first axis, includes a plurality of links.

In another refinement the plurality of links includes a main link that is larger than at least one of the other links.

In another refinement a link, preferably the main link, defines an opening for a battery, preferably a coin cell battery.

In another refinement the battery at least partially overlaps the plane of the

In another refinement at least one of the links includes rounded edges. In another refinement at least one of the links includes a stop to preclude flexing past a predetermined angle.

In another refinement the majority of the links are smaller than the main link. In another refinement all of the links are smaller than the main link.

In another refinement the plurality of links includes two smaller links adjacent to the main link, and each of the two smaller links includes a battery that is electrically connected to at least one of the MCU and the driving electronics.

In another refinement the end link of the plurality of links includes an opening sized to mate with a protrusion from the module containing the display and associated controlling electronics.

In another refinement at least two of the MCU, PCB and driving electronics spatially overlap one or more of the links.

In another refinement each individual link does not flex.

In another refinement the means for restricting twist, or the means for limiting flex to a single axis, or means for permitting flex in a first axis and limiting twist in a second axis different from the first axis, or means for permitting flex in a first axis and limiting flex in a second axis different from the first axis, is a sheet. The sheet material is selected from the group consisting of plastic or metal.

In another refinement the sheet includes additional support segments to reduce twist.

In another refinement the means for restricting twist, or the means for limiting flex to a single axis, or means for permitting flex in a first axis and limiting twist in a second axis different from the first axis, or means for permitting flex in a first axis and limiting flex in a second axis different from the first axis, includes a plurality of non-flexible supports integrated within a case material.

In another refinement there is an outer casing constructed as a sleeve with at least one opening into which a module that includes the flexible display and the MCU is inserted.

In another refinement the linkage assembly is secured directly to an internal portion of the casing to hold the module in place.

In another refinement the protrusions are on an internal portion of the outer casing and interface with the buttons located in the strap portion of the outer casing.

In another refinement the one or more electrical connections are positioned over a non-flexible portion of the means for restricting twist, or the means for limiting flex to a single axis, or means for permitting flex in a first axis and limiting twist in a second axis different from the first axis, or means for permitting flex in a first axis and limiting flex in a second axis different from the first axis.

In another refinement the flexible display is selected from the group consisting of and electrophoretic display, a liquid crystal display, or an organic light emitting diode display.

In another refinement the flexible display is an electrophoretic display.

In another refinement the flexible display includes a frontlight having at least one light emitting diode.

In another refinement the flexible display is an organic tight emitting diode display.

In another refinement the flexible display is a liquid crystal display.

In another refinement the transparent layer is silicone.

In another refinement the casing is silicone.

In another refinement the transparent layer and/or the casing is polyurethane.

In another refinement the casing is leather and the transparent layer is silicone.

In another refinement the casing is a flexible metal.

In another refinement the links include polyphenylene sulfide.

In another refinement the casing includes a magnet near an end of a strap portion of the casing, the magnet being within a protrusion from a surface of the casing, the cross-section of the protrusion being approximately the same as each of a plurality of sizing openings that begin near another end of the strap and are spaced apart toward the flexible display.

In another refinement the sizing openings include material possessing some magnetic attraction.

In another refinement there is screen printing on a east a portion of the strap portion of the casing.

In another refinement the screen printing is of a substantially transparent gloss.

In another refinement the substantially transparent gloss is present on a majority of the surface area of the casing.

In another refinement a brand or logo is screen printed on the casing.

In another refinement a brand or logo is screen printed to overlap at least a portion of the flexible display.

In another refinement a strap portion of the casing includes laser etching.

In another refinement the casing includes two leather straps bound together.

In another refinement the two leather straps are sewn together.

In another refinement the at least one of the bottom of the transparent layer and the top of the flexible display includes a matte finish.

In another refinement the at least one of the bottom of the transparent layer and the top of the flexible display includes a coating to minimize the formation of air pockets.

In another refinement the bottom of the transparent layer includes a matte finish and further includes a coating to minimize the formation of air pockets.

In another refinement the power source is a coin cell battery.

In another refinement the coin cell battery is positioned in an opening in one of the links, preferably the main link.

In another refinement there is further included a padding layer.

In another refinement the padding layer is positioned between at least a portion of the flexible display and the PCB.

In another refinement the MCU a driving electronics are bonded onto a flexible printed circuit board.

### BRIEF DESCRIPTION OF THE FIGURES

FIG. 1 is a cross sectional view of an embodiment of a flexible device.

FIG. 2 illustrates aspects of a side cross-sectional view of a non-bendable portion of an embodiment in which a microcontroller or driving electronics could be positioned.

FIG. 3 is a top view of a battery positioned at least partially within the means for restricting twist integrated in a flexible digital watch embodiment.

FIG. 4 is a cross sectional view of an embodiment with a battery co-located in the same axis as the twist reduction link.

FIG. 5A is a view of an assemblage of links that provide a bendable structure while restricting twist.

FIG. 5B is a bottom perspective view illustrating a stop mechanism integrated within links.

FIG. 6 is a side view of aspects of a structure of another embodiment of a means to restrict twisting.

FIG. 7 is a cross-sectional view of an embodiment of a flexible watch assembly.

FIGS. 8A-8C are side, bottom, and top views, respectively illustrating various features of one embodiment of a flexible digital watch,

FIG. 9A illustrates a top view of the overall finished appearance of an embodiment of a flexible digital watch,

FIG. 9B illustrates a bottom view of the overall finished appearance of an embodiment of a flexible digital watch.

### DETAILED DESCRIPTION OF THE PREFERRED EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The emergence of flexible display technologies (including electrophoretic displays, LCDs, and OLED displays) now enables the possibility of new designs and aesthetic features for mobile products. Many mobile products comprise a display, power supply (typically a battery), and user interface, at least some of which are positioned partially within and/or part of a case. Such products can be transformed via implementation of various flexible display technologies for mass production. Current flexible display technologies have significant limitations that impact their reliability. One such limitation is that two plastic substrates may be able to flex in one axis to a certain radius of curvature. However, the substrates are much more limited in other axis. For example, twisting or torsion forces can cause significant shearing stresses between adhesive layers that can cause de-lamination leading to display failures. One solution would be the use of plastics that are so thin and ultra-flexible with such a low durometer that these stresses would not be an issue. However, production of any of these display technologies using a non-rigid plastic is extremely difficult.

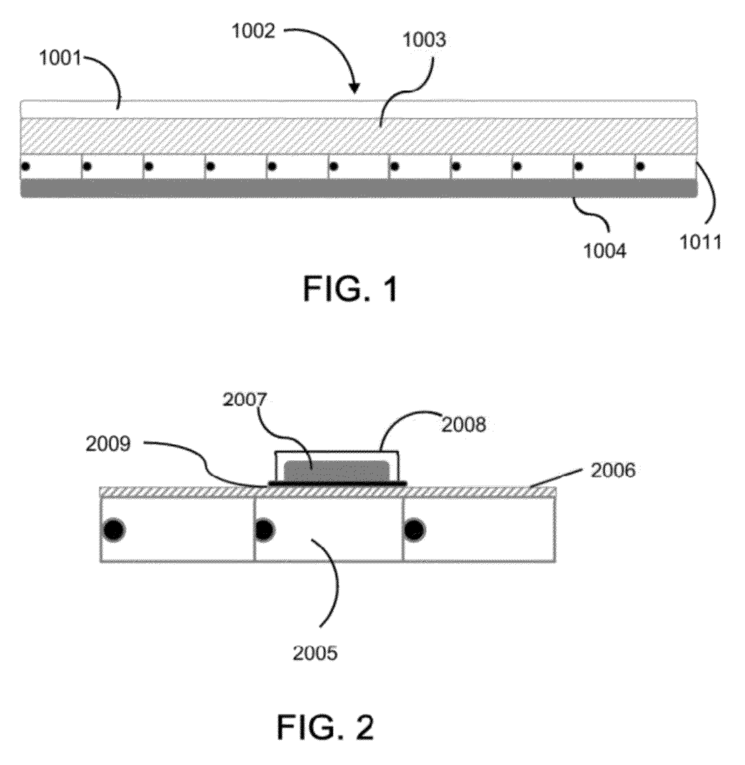

FIG. 1 illustrates aspects of a mobile device 1002 having a flexible display. A first outer transparent layer 1001 encases at least a portion of the flexible display 1003. Those of ordinary skill in the art will understand that referring to layer 1001 as transparent means that the majority of the surface area of one side of the layer 1001 is transparent. Layer 1001 is considered transparent even if portions of it are opaque or translucent, or if portions are covered by an opaque top casing. Positioned behind the transparent layer 1001 is the flexible display 1003. Examples of a flexible display 1003 include, but are not limited to, electrophoretic displays, LCDs, and OLED displays. Located within the mobile device 1002 between the transparent layer 1001 and the back casing 1004 is a means for substantially restricting (preferably severely reducing and even more preferably eliminating) twist in other than the flexing axis.

In many mobile devices, particularly watches, there is typically spacing between the top transparent layer 1001 and an underlying display. This spacing is present because the displays are typically constructed out of glass and are subject to breakage should significant pressure be applied to an outer surface (that can flex and apply pressure and possibly break the underlying glass display). In a flexible mobile device 1002 (in particular a watch) subject to flexing it is preferable to have minimal empty spaces, and even more preferable to have no empty spaces. Minimal to zero spacing is preferably present between the flexible display 1003 and outer transparent layer 1001. To permit flex in the mobile device or watch 1002 both the layer 1001 and other casing materials should be constructed from a flexible material. Such flexible materials include, but are not limited to, silicone, soft plastics, or rubbers.

Layer 1001 preferably contacts the top surface of the flexible display 1003. Since both are preferably made of soft and/or flexible materials, air pockets might be visible between the two layers (sometimes described as the watermark effect). Visible air pockets are not desired, and a special coating is preferably applied to at least one, if not both, of the bottom surface of the layer 1001 or the top surface of flexible display 1001 The coating adds some diffuseness to optical clarity as it typically includes tiny materials or particles acting as micro spacers between the two layers to prevent the formation of air pockets visible when the two surfaces are in contact. In another refinement the bottom surface of the layer 1001 has a matte finish that, when in contact with the top of the flexible display 1003, assists in minimizing or preventing the formation of air pockets.

Twist reduction mechanism 1011 preferably permits flexing of the flexible display 1003 (and mobile device 1002) substantially in only one axis. As used herein, twist reduction or restriction refers to permitting flexing or bending in a single axis (and in some embodiments limiting the amount of flexing on that single axis), but allowing zero to an insignificant amount of flexing in any other axis. Twist reduction mechanism 1011 preferably significantly reduces, and even more preferably substantially prevents, one or more modes of twisting of the mobile device 1002 that could result in failure of the flexible display 1003. In one embodiment the means for reducing twist 1011 includes a linkage design. The twist reduction mechanism 1011 preferably includes a linkage design that can be customized to significantly limit twisting, The twist reduction mechanism 1011 even more preferably also includes a construction of the links designed to also allow a limited amount of flexibility in the preferred axis of flexibility, The twist reduction mechanism 1011 can comprise links constructed out of metals, or plastics. In one preferred embodiment the links are manufactured from hard plastics such as polyphenylene sulfide (PPS). Other embodiments of twist reduction 1011 mechanisms are contemplated as within the scope of the present invention. One example is a flexible plastic, but with cross sectional supports to reduce and/or prevent twistability. Another example is a frame construction that is hinged and allows flexing or bending only in one axis and only within the limitations of the flexible display 1003.

In consumer products ranging from mobile phones to wrist watches there are two other required components (not illustrated in FIG. 1). First, a power source that typically includes a battery, preferably and most commonly a coin cell battery in watch applications, The power source could include a solar cell, preferably a solar cell connected to a battery (that consequently does not need to be a replaceable and/or removable battery). Second, the electronics comprising at least one microcontroller and supporting driving electronics. Any portion of the MCU or controlling electronics that would lie within the same cross section of the flexible display 1003 would likely be integrated on a flexible printed circuit board (PCB). In one variation the controlling electronics could reside in a cut-out within the twist reduction mechanism 1011 as well.

FIG. 2 illustrates another embodiment in which a portion of a product is flexible. Various consumer products typically include at least one microcontroller unit (MCU) 2007, and often multiple electronic components. Discrete components such as resistors and capacitors can be placed onto a flexible printed circuit board (PCB) 2006 and be subjected to some flexing. Such discrete components are connected to a small region and generally only include two contact points. However, problems can arise with respect to more complex electronics such as MCUs 2007, and other driving components bonded to a flexible PCB 2006 that is then subjected to significant flexing.

Excessive flexing or bending can often cause failure of the bonding (such failure resulting in loss of one or more connections). For complex electronics (MCU 2007 or display driver) there might be dozens to hundreds of connections made to the flexible PCB 2006. Consequently, the portion including complex electronics is preferably first connected to flexible PCB 2006, and located over a non-bendable link 2005 of the twist reduction mechanism. Depending on size, the MCU 2007 for other complex electronics) can be positioned over a link 2005 that might differ in size and shape from the neighboring individual links to limit flexing. The product might also include an integrated circuit (IC) upper guard 2008 as well as an IC lower guard 2009 (see FIG. 2). Each of the guards 2008 and 2009 might be some type of PCB stiffener materials. The IC guard materials serve to protect MCU 2007 and restrict or prevent any flexing, particularly in regions that could result in loss of one or more connections.

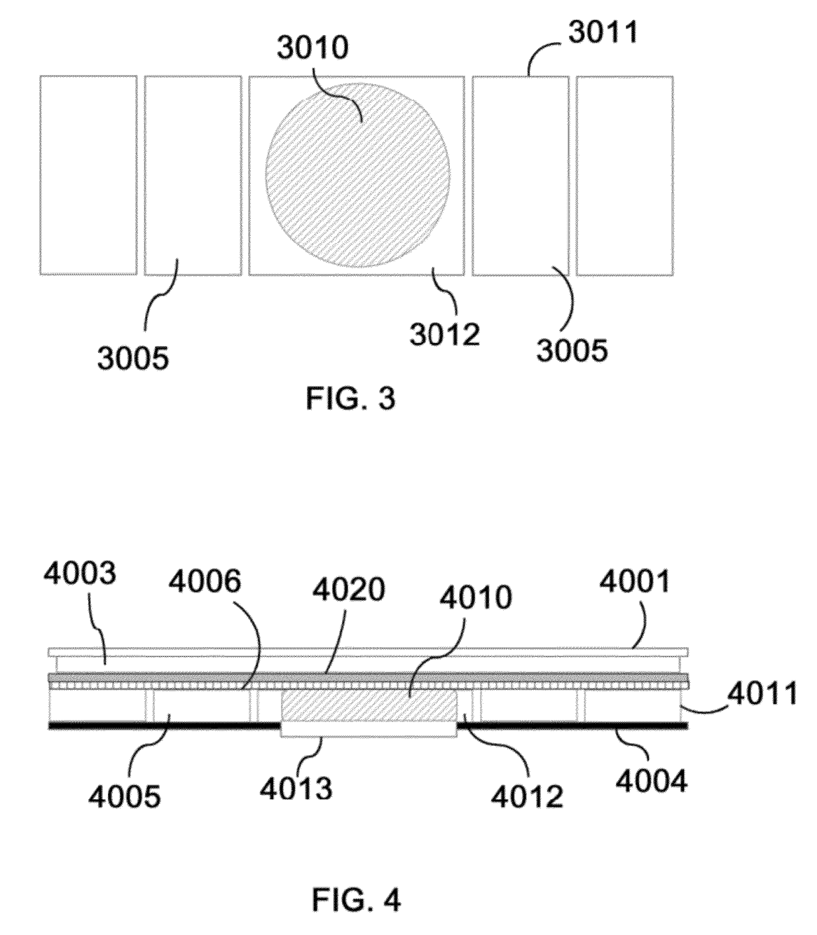

Referring to FIG. 3, there is a battery 3010 in a flexible wrist watch or other mobile device. Battery 3010 is a coin cell battery 3010, it being understood that other types of power sources or other shaped battery 3010 might be used. FIG. 3 illustrates a twist reduction assembly 3011 and individual links 3005. Battery 3010 preferably overlaps a link 3012 that is larger than other links 3005. A single larger link 3012 among smaller links 3005 provides for the possibility of improved consumer or aesthetic appeal. For example, it might permit a thinner mobile device, while at the same time providing a twist reduction assembly integrated within the mobile device. Alternatively, improved customer perceptions of flexibility might result from providing two or more smaller batteries. Smaller batteries positioned in separate links 3005 with link 3012 hinged between them would result in increased flexibility.

FIG. 4 illustrates a battery 4010 co-located in the same plane as a main twist reduction link 4012. Linkage 4012 having adjacent thereto links 4005, that are smaller in at least one dimension to permit increased flexibility. Outer case 4004 includes a transparent outer layer 4001 positioned above the flexible display 4003. Referring to layer 4001 as transparent again implies that the majority of the surface area of the layer is transparent. Layer 4001 is considered transparent even if portions of it are opaque or translucent, or if portions are covered by an opaque top casing. Examples of a flexible display 4003 include, but are not limited to, electrophoretic displays, LCDs, and OLED displays. For display types such as a LCD a backlight might typically be used. For a reflective display technology such as electrophoretic a front light is preferably used. Frontlights or backlights are part of the flexible display assembly 4003 as preferred,

Referring to FIG. 4, flexible PCB 4006 is designated with cross-hatching, and beneath it is the means for restricting twist 4012 that overlaps the battery 4010. Case back housing 4013 allows for access to the battery 4010 for replacement. A wrist watch preferably includes some level of water resistance ranging from splash resistant to 3ATM, 5ATM, or even as high as 10ATM. Transparent layer 4001 (preferably a transparent portion of the casing) and outer casing 4004, and battery caseback 4013 are preferably designed to possess some level of water resistance. The controlling electronics and supporting electrical components are preferably, but not necessarily, located on the flexible PCB 4006 in the region beneath the flexible display 4003. There is preferably further included a padding layer 4020. Padding layer 4020 might be positioned either between the flexible display 4003 and flexible PCB 4006 layer as shown in FIG. 4, or between flexible PCB 4006 and means for reducing twist 4011. Padding layer 4020 assists in protecting the display from stress applied during twisting or flexing of the device, and damage that could be caused to the display from the harder twist reduction mechanism 4011 pressing against it. Layer 4020 could be a thin soft material including, but not limited to, silicone, rubber or other low durometer materials.

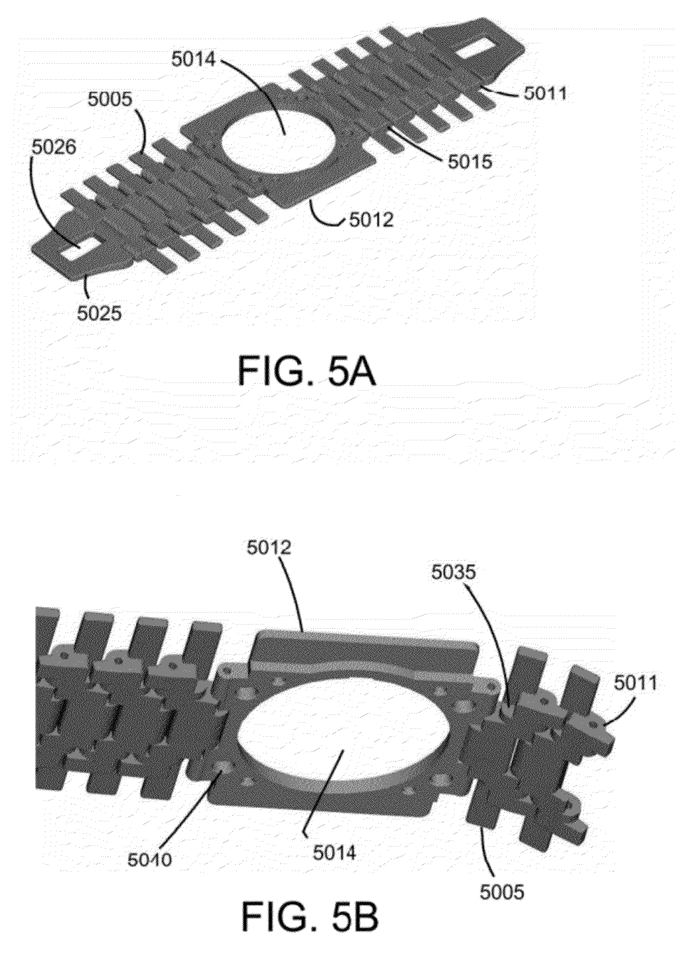

One embodiment including a means for restricting twist in a watch that must wrap around a wrist is the linked chain of FIG. 5A. Individual links 5005 are connected. forming linkage assembly 5011. Linkage assembly includes a larger central link 5012. Main link 5012 includes an opening 5014 to permit a coin cell battery to be at least partially located within the same plane as the linkage assembly 5011. Linkage assembly 5011 allows flexibility in one preferred axis to some degree, but significantly limits or prevents twisting in the other directions or axis of rotation. Linkage 5005 includes some interconnection 5015, that might be a pin inserted through some portion of both of the adjacent links 5005, thereby holding them together.

A wide variety of connections between adjacent links 5005 are contemplated as within the scope of the invention. Such connections preferably permit some rotation and not a fixed, permanent orientation with respect to each other. For some applications it might be preferable to provide some flex in a single axis, but such flex not to exceed that beyond which the flexible display might fail over expected product lifetime. The individual link 5005 can be designed to allow the maximum amount of desired axis of flexibility that the flexible display can reliably tolerate repeatedly over product lifetime. In one refinement the design includes end links 5025, that preferably include a taper. End link 5025 is constructed out of softer material than links 5005 and 5012. End link 5025 also preferably includes an opening 5026 therein. Opening 5026 fits over a corresponding protrusion inside the main casing, This feature insures that linkage assembly 5011 does not float and/or shift within the assembled watch or device and it is held in place with respect to the overall outer casing.

Referring to FIG. 5B, the linkage assembly 5011 exhibits some rotation between each adjacent link 5005 in the portion that is bending or flexing in its single preferred axis. Links 5005 preferably include some degree of rounded edges. Rounded edges increase the amount of flexibility or bending of the wrist watch in the single desired bending axis. However, other embodiments are contemplated as within the scope of the invention using links 5005 that are less rounded on the edges where links interface. More squared off individual links 5005 reduce the amount of rotation. Additional design elements can also be integrated into the linkage assembly 5011 to reduce or prevent flexibility beyond the limitations of the internal components. Stops 5035 might also be included to prevent flexing in the preferred axis past some predetermined angle. FIG. 5B illustrates an enlarged view of the larger main link 5012 that includes opening 5014 for a battery (preferably positioned at least in part in the same plane). Link 5012 also preferably includes openings 5040 to fix linkage assembly 5011 to protrusions in the main casing or to the flexible PCB or flexible display.

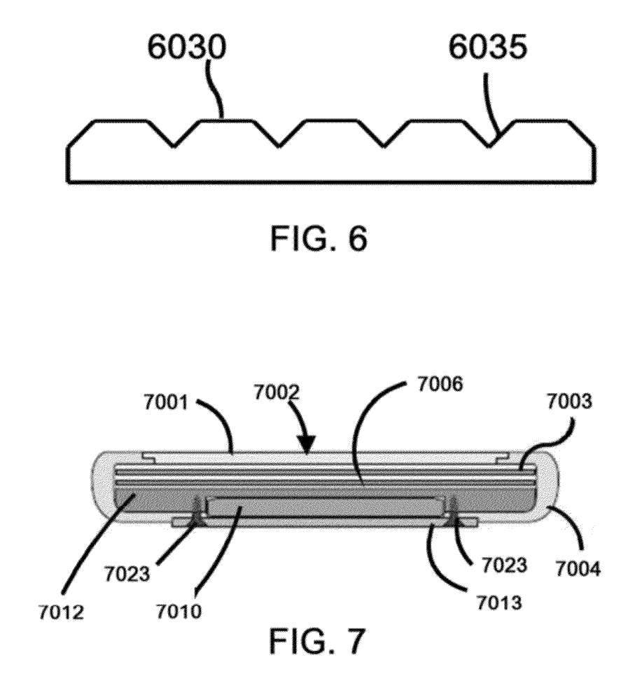

FIG. 6 illustrates aspects of another potential means for restricting twist in a flexible mobile device. A thin sheet of material 6030 is employed that can be constructed using any number of plastics or metals. At least one side of thin sheet 6030 includes geometric features or pattern 6035. Features or pattern 6035 are either present as part of the construction of the thin sheet 6030, or affixed to the thin sheet 6030. The geometrical features are designed to limit the degree of flexibility in at least one axis. These features 6035 can also be designed to reduce twistability as well.

Referring to FIG. 7, flexible digital watch 7002 includes an outer casing 7004. At least a portion of casing 7004 is constructed out of a flexible material including but not limited to, various plastics, rubber or silicone, as well as flexible metal, or leather. Casing 7004 at least partially, and preferably entirely, encases the flexible display 7003, a power source that is typically a battery 7010, and controlling electronics on flexible PCB 7006. Top transparent layer 7001 can be made of the same materials as the outer casing 7004 and produced in a single production procedure. Alternatively, top layer 7001 is a different material that is later bonded by heat or adhesive to the casing 7004. For example, attaching a silicone transparent top layer 7001 to a leather or flexible metal casing 7004. As with previously described embodiments, in one refinement a coating is applied to the bottom surface of the transparent top layer 7001 to prevent the formation of any air bubbles or “watermark” visible effects. At least partially within the casing 7004 is the module that includes flexible display 7003, flexible PCB 7006, and twist restriction linkage assembly 7012. A padding layer could also be included, preferably inserted between the flexible display 7003 and the twist restriction linkage assembly 7012 to reduce the chances of damage to the flexible display 7003 during product life. Battery 7010 overlaps main link 7012. Battery hatch 7013 can take many forms, but in FIG. 7 the hatch 7013 is a piece of plastic or metal attached by screws 7023 to link 7012.

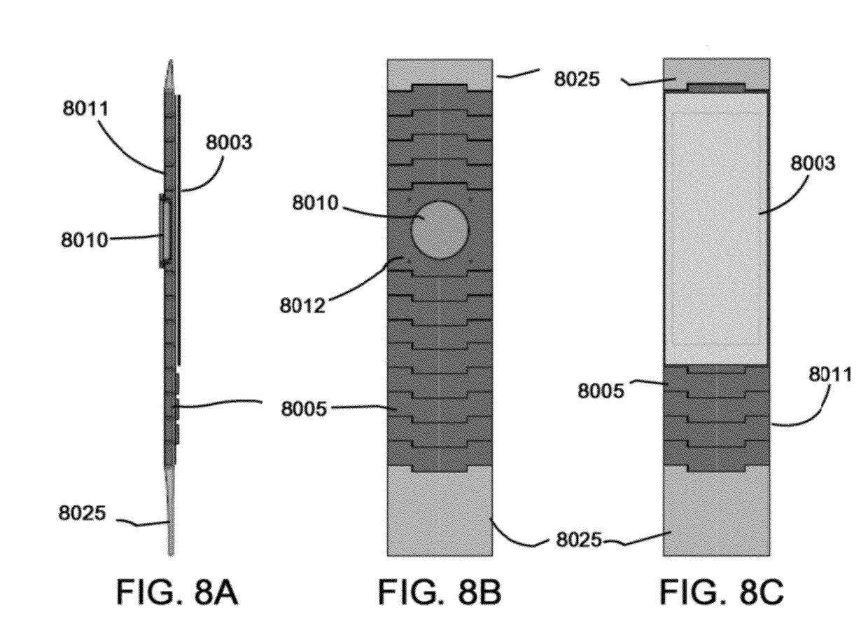

Referring to FIGS. 8A-8C there is a module for a flexible digital watch that includes linkage assembly 8011, battery 8010, and flexible display 8003. As shown in FIG. 8B the battery 8010 preferably fits into main link 8012 that is slightly larger than individual links 8005. To reduce the size of main link 8012 one could use batteries 8010 with a smaller diameter, or put two smaller diameter batteries 8010 side-by-side. Alternatively, one could put smaller diameter batteries 8010 on different smaller links 8012. FIG. 8C illustrates one orientation of a flexible display 8003 on a portion of linkage assembly 8011. The linkage assembly 8011 reduces the twisting to which the flexible display 8003 can be subjected. Additionally, linkage assembly 8011 might also be designed to reduce the flexibility of the overall mobile device.

Alternative mechanisms could be used instead of linkage assembly 8011. Such mechanisms might comprise a plastic or metal sheet, or supports integrated as an underlying structure or within the outer casing (not shown in FIG. 8). FIGS. 8A-8C also illustrate the preference to reduce the overall thickness of the watch in the regions where the flexible display 8003 is located. In some cases the outer casing (not shown in FIG. 8) might taper down to be thinner in the strap area. When the outer casing is produced using compression and/or heat injection molding technique (using plastics or silicone to produce a sleeve with at least one opening) the tapered down area that does not contain a module might need to be filled with some material. End link 8025 might preferably comprise a flexible elastomer filler material ranging from plastic, silicone or flexible metal, and often tapers to a decreased thickness. End link 8025 is attached to linkage assembly 8011 and inserted into the outer casing in the strap region.

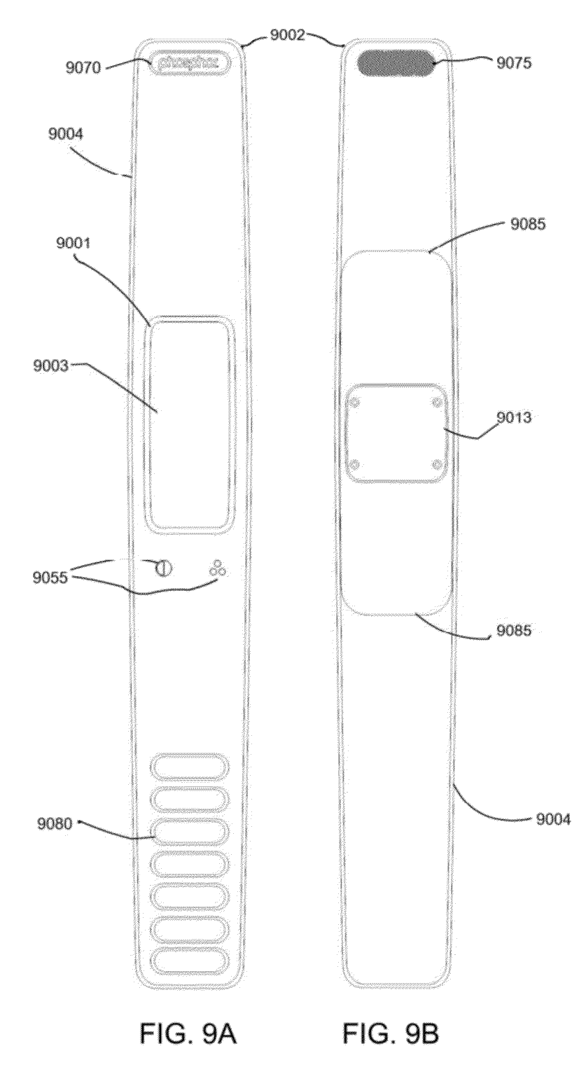

Referring to FIGS. 9A-9B, flexible watch 9002 includes a transparent top layer 9001 over a flexible digital display 9003. Layer 9001 and display 9003 are at least partially surrounded by the outer casing 9004. Water resistance is a standard feature in watches. Thus, flexible display 9003 and supporting electronics are preferably enclosed in a water tight case construction. Some products that incorporate new flexible display technologies and may only need some level of “splash.” water resistance can be constructed without the need for the top transparent layer 9001 over the flexible display 9003. In such designs the top surface of the flexible display 9003 is external and accessible to touch. It is contemplated as within the scope of this invention that a flexible watch or mobile device as taught herein could also be constructed without the top transparent layer 9001, and only include the outer casing 9004. When transparent layer 9001 is not present over the flexible display 9003 there may be sealant applied around the outer casing 9004 along the window where the flexible display 9003 is visible.

Referring to FIGS. 9A-9B, the size of the flexible display relative to the watch is not necessarily to scale, and is only representational. That is to say, the flexible display 9003 as illustrated is only a small portion of the overall flexible watch 9002. Economies of scale and other factors should drive the price of flexible displays downward and result in greater reliability when bent. As reliability improves and price decreases the flexible display 9003 and corresponding top transparent layer 901 might be increased in size and result in an even longer display in strap than is illustrated FIGS. 9A-9B. Both the top transparent layer 9001 and outer casing 9004 can be constructed out of any variety of plastics, ranging from polyurethanes (PU) to silicones, or other flexible materials such as rubber, etc. In one variation the top transparent layer 9001 is a flexible plastic such as silicone or polyurethane, and is attached to a flexible outer casing 9004 material. Flexible outer casing material could be plastic, silicone, leather, or flexible metal. Examples of such metals include, but are not limited to, thin (preferably very thin) flexible metals such as aluminum or steel.

Watches and other mobile devices often use one or more buttons or user interface components, such as membrane switches, or dome push buttons, or any number of existing implementations. Referring to FIGS. 9A-9B, the buttons 9055 are placed within the flexible case construction in the strap region, Buttons 9055 include switches underlying the flexible outer casing 9004. Small protrusions are preferably used on the outer casing 9004, such protrusions being positioned to overlap the buttons 9055 located. on flexible PCB internally. Thus, pressure on the outer casing results in button press. However, optimization of the design is useful so that flexing of the watch does not result in pressure activation of the buttons 9055. In another variation (not illustrated in FIGS. 9A-9B) the buttons 9055 could be located underneath the flexible display 9003, and activated by pushing on the flexible display 9003 in that area of the button 9055 location.

Various known watch closure mechanisms can be employed on a flexible digital watch to connect the straps together as they wrap around the wrist. Examples include, but are not limited to, standard buckle with holes in strap, butterfly closures, etc. The embodiments disclosed herein are preferably used with the magnetic closure mechanism discussed herein. Top surface of watch 9002 includes a logo plate 9070 that overlaps closure magnet 9075 protruding from the bottom side. Magnet 9075 is preferably a neodymium magnet. Top side of outer casing 9004 includes sizing holes 9080 located in the strap sizing region. Magnets or steel material are positioned beneath the sizing holes 9080, preferably at least partially within outer casing 9004. Flexible digital watch 9002 is wrapped around the wrist, and the protruding closure magnet 9075 is fitted into the appropriate sizing hole 9080. The magnets or steel located beneath each sizing hole provides a magnetic attractive surface for retention. The sizing holes 9080 enable the protrusion of the closure magnet 9075 to fit therein, and provides additional holding strength so that shearing forces do not easily cause the band to come undone from the wearer. One or more magnets could be used on the closure magnet 9075 side or on sizing holes side 9080 of the strap to provide additional holding strength.

Referring to FIG. 9B, in one preferred embodiment the outer casing 9004, preferably including a transparent portion that serves as top layer 9001, is produced out of at least one mold using either silicone pressure mold or injection molding. This single outer casing 9004 portion has an opening where the module including the flexible display 9003, controlling electronics on flexible PCB, and twist reduction mechanism is inserted. These components are bottom loaded and secured within and often connected directly to the inner portions of the outer casing 9004. External patch 9085 is then adhered to the opening of the outer case 9004 seating the module therein and providing some level of water resistance, The patch can be secured to the outer casing by a variety of means, but preferably via adhesives. The battery is inserted and the battery cover 9013 is secured by screws to the main link.

In another embodiment the production of the flexible watch 9002 includes an outer casing 9004 made out of silicone or polyurethane plastic produced by placing a dummy module into a mold, and the outer casing 9004 is then formed through compression or injection molding techniques after which the dummy module is then removed. Using this production technique the outer casing 9004 is effectively like a sleeve that can have either one or both ends open. The opening in the formed flexible outer casing 9004 is then used to insert the flexible watch module assembly. Then one or both ends of the outer casing 9004 can be sealed by heat, sealant, adhesive, or even a cap so that some level of water resistance can be achieved for the flexible wrist watch or mobile device. Additional areas within the plastic or silicone outer casing construction can also be added that would hold the display and the flexible PCB in place. On a watch that will be subjected to bending such permits the flexible display 9003 to stay in the correct position with the top transparent layer 9001. Such also aids in insuring that the underlying flexible PCB does not bunch up in any area of the assembly, but remains in a fixed position after being inserted in the production process.

Those of ordinary skill in the art will understand that a variety of flexible displays might be used in any embodiment of the present invention. Such flexible displays include any of a variety of technologies including, but not limited to, electrophoretic, liquid crystal, and OLED. Those of ordinary skill in the art will further understand that a front light or backlight could be used in conjunction with electrophoretic or liquid crystal displays, respectively, and such lighting is considered to be part of the flexible display assembly whenever illustrated in the figures herein. Prototypes of one embodiment have been made that include an electrophoretic display using segmented displays. However, other embodiments contemplated as within the scope of the invention include, but are not limited to, a matrix electrophoretic display, or matrix OLED display.

A wide variety of shapes and sizes of flexible displays are contemplated as within the scope of the present invention. In one embodiment the display has a width of about 16 mm to 20 mm and a length of about 45 mm to 50 mm. It will be understood by those of ordinary skill in the art, however, that the display is not limited to rectangular shapes. For example, electrophoretic displays (E INK. displays) permit rounded or curved shapes. As another example, persons of smaller stature will typically prefer a watch display better sized for their arm and/or hand, and thus might prefer a watch with a smaller display. Similarly, watches marketed to males are often larger, and might include a larger display.

As previously noted, some embodiments include a transparent layer that preferably contacts the top surface of the flexible display. Since both are preferably made of soft and/or flexible materials, air pockets might be visible between the two layers (sometimes described as the watermark effect). In all such embodiments visible air pockets are undesirable. To minimize the resulting “watermark effect” a special coating is preferably applied to at least one, if not both, of the bottom surface of the top layer or the top surface of flexible display. Such coating is preferably added to the bottom surface of the top layer. Another mechanism for addressing the “watermark” effect is providing a matte finish to at least one, if not both, of the bottom surface of the top layer or the top surface of the flexible display. Again, such matte finish is preferably added to the bottom surface of the top layer, it is also contemplated that both a matte finish and a coating could be provided. For ease of manufacture the matte finish and coating are preferably, but not necessarily, both on the same surface (again preferably the bottom surface of the top transparent layer).

Some embodiments of the present invention preferably include a means for restricting twist integrated within the case of the mobile device or wrist watch, or within the outer case construction itself. These “integrated” embodiments aid in providing one or both of two outcomes. The first is to preferably insure that the portion of the product where the flexible display is located can not be subjected to twisting forces that would cause failure of the flexible display. The second is to preferably prevent the overall product and the display from flexing in the provided for axis of flexibility beyond the limitations or radius of curvature of the display.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow, In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1-69. (canceled)

70. A watch comprising:
a flexible digital display capable of displaying at least one of chronological, graphical, or data information;
at least one microcontroller unit (MCU) electrically connected to the flexible display;
a power source electrically connected to the flexible display; and
means for reducing twist of the flexible digital display, wherein the means for reducing twist is positioned beneath and at least partially overlaps the flexible digital display.

71. The timepiece of claim 70, wherein the means for reducing twist includes a plurality of interconnected links having a main link that is larger than at least one of the other links and the main link defines an opening for receiving the power source in the form of a coin cell battery, and wherein the battery overlaps the plane of the main link.

72. The timepiece of claim 70, wherein the means for reducing twist comprises a plurality of non-flexible supports integrated within a case material.

73. The timepiece of claim 70, wherein the flexible digital display is selected from the group consisting of an electrophoretic display, a liquid crystal display, or an organic light emitting diode display, and further including a transparent layer on top of the flexible digital display.

74. The timepiece of claim 73, wherein the, transparent layer is a portion of a polymer casing that encloses at least a portion of the means for reducing twist of the flexible display, and a display face of the flexible digital display abuts the transparent portion of the polymer casing, and wherein the polymer casing includes a magnet near an end of the casing, the magnet having a cross-section approximately the same as each of a plurality of sizing openings that begin near another end of the casing and are spaced apart longitudinally from the another end toward the flexible digital display.

75. The timepiece of claim 73, wherein the transparent layer is a portion of a polymer casing that encloses at least a portion of the means for reducing twist of the flexible display, and a display face of the flexible digital display abuts the transparent portion of the polymer casing, and wherein the means for reducing twist includes a linkage assembly that is secured directly to an internal portion of the polymer casing.

76. A timepiece comprising a flexible display positioned substantially within a polymer casing that also encloses at least a portion of a means for restricting twist of the flexible display, wherein a display face of the flexible display abuts a substantially transparent portion of the casing, and wherein the flexible display is electrically connected to a power source and to controlling electronics for causing the display to present temporal information.

77. The timepiece of claim 76, wherein the flexible display is selected from the group consisting of an electrophoretic display, a liquid crystal display, or an organic light emitting diode display.

78. The timepiece of claim 77, wherein the means for restricting twist includes a plurality of interconnected links.

79. The timepiece of claim 78, wherein the plurality of links includes a main link that is larger than at least one of the other links, and wherein the power source is a coin cell battery and the main link defines an opening in which the battery is positioned.

80. The timepiece of claim 77, wherein the polymer casing, includes a magnet near an end of the casing, the magnet being within a protrusion from a surface of the casing, a cross-section of the protrusion being approximately the same as each of a plurality of sizing openings that begin near another end of the casing and are spaced apart longitudinally from the another end toward the flexible digital display.

81. A watch module comprising a spine for permitting limited flex in a first axis and restricting twist in other axis by overlapping a flexible display electrically connected to a microcontroller and driving electronics that are electrically connected to a flexible printed circuit board, wherein the spine comprises a plurality of interconnected links and wherein adjacent links are interconnected to permit only limited flex in the first axis.

82. The watch module of claim 81, wherein the plurality of links includes a main link, that is larger than at least one of the other links

83. The watch module of claim 82, wherein the main link defines an opening for a battery,

84. The watch module of claim 83, wherein the battery is a coin cell battery, and wherein the battery at least partially overlaps the plane of the main link.

85. The watch module of claim 84, wherein at least one of the links includes rounded edges, and wherein the majority of the links are smaller than the main link.

86. The watch module of claim 84, wherein the microcontroller unit, printed circuit board, and driving electronics each overlap the main link.

87. The watch module of claim 81, wherein at least one of the links includes a stop to preclude flexing past a predetermined angle.

88. The watch module of claim 81, wherein the flexible display is selected from the group consisting of an electrophoretic display, a liquid crystal display, or an organic light emitting diode display.

89. The watch module of claim 88, further including a transparent silicone layer having a bottom face that abuts a top face of the flexible display, wherein at least one of the bottom face of the transparent layer and the top face of the flexible display includes a matte finish, and further including a removable battery positioned within an opening defined in one of the plurality of links.
